(19) United States
(12) Patent Application Publication
(10) Pub. No.: US 2002/0107704 A1
(43) Pub. Date: Aug. 8, 2002

(54) Network based fitness system

(75) Inventor: Don Spyker, Mesquite, TX (US)

Correspondence Address: Todd E. Landis, Gardere Wynne Sewell, LLP, 3000 Thanksgiving Tower, 1601 Elm Street, Suite 3000, Dallas, TX, 75201-4767, US

(73) Assignee: BFA Network, Inc.

(21) Appl. No.: 09/779,798

(22) Filed: Feb. 8, 2001

(51) Int. Cl. G06F 17/60

(52) U.S. Cl. 705/2

(57) ABSTRACT

The present invention provides a fitness system for use across a telecommunications network. The fitness system may include one or more computers having one or more users desiring motivational support for workouts. The fitness system may also include a fitness server communicably linked to the one or more computers through the telecommunications network and being configured to provide exercise routines, parameters, tracking, and motivational assistance.

### TECHNICAL FIELD OF THE INVENTION

The present invention relates generally to fitness systems and more particularly to network based fitness systems.

### BACKGROUND

Without limiting the scope of the invention, it's background is described in connection with online fitness systems. In today's society being fit is becoming more of a priority for many people. Reducing stress and reducing health risks are just some of the reasons more and more people are beginning to workout. Some people workout to reduce the amount of fat in their bodies. Some people workout to have more defined figure and some people workout to build their muscle mass.

Most people desire to workout but have problems maintaining their motivation. Likewise, those people often have problems designing appropriate workout programs for their workout goals. To overcome these deficiencies, many people seek the advice of personal trainers. Personal trainers can provide the individual with the necessary instruction on workout routines, cardiovascular exercises, dietary schemes and the like. Most importantly, however, personal trainers provide motivation to individuals seeking better fitness. The problem with personal trainers is that they are expensive and require scheduling appointments during available time slots. This requires coordination of schedules and is subject to changes or cancellations depending upon the schedule of the individual. Therefore, a need has arisen to develop a system to provide the conveniences of a personal trainer without the hassle of scheduling.

### SUMMARY OF THE INVENTION

The present invention provides a fitness system for use across a telecommunications network. The fitness system may include one or more computers having one or more users desiring motivational support for workouts. The fitness system may also include a fitness server communicably linked to the one or more computers through the telecommunications network and being configured to provide exercise routines, parameters, tracking, and motivational assistance.

The present invention further provides a method of personal training across a global communications network. The method may include the step of specifying a fitness level for at least one person. The method may also include the step of electing a goal for the person. In addition, the method may include the step of selecting a workout program corresponding to the goal. The method may further include the step of charting progress of the person in the chosen workout program. The method may also include providing motivational statements to the person via the global communications network, wherein the motivational statements encourage the person to continue with and fulfill the workout program.

### BRIEF DESCRIPTION OF THE DRAWINGS

For a more complete understanding of the features and advantages of the present invention, reference is now made to the detailed description of the invention along with the accompanying figures in which the corresponding numerals and the different figures refer to corresponding parts and in which:

FIG. 1 is a network diagram of the fitness system of the present invention;

FIG. 2 illustrates diagrammatically the components of the fitness server of the present invention;

FIG. 3 illustrates diagrammatically the components of the workout module of the fitness server;

FIG. 4 illustrates diagrammatically the components of the membership module of the fitness server;

FIG. 5 illustrates diagrammatically the components of the e-mail module of the fitness server;

FIG. 6 is a block diagram showing the initial operation of the fitness system;

FIG. 7 is a block diagram showing the new member sign-up page of the fitness system; and

FIG. 8 is a block diagram showing the creation of a member page.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of the specific ways to make and use the invention and do not delimit the scope of the invention.

The present invention provides a network based system that can operated on a wide variety of hardware and software configurations. Due to the range of hardware configurations, the present invention can be easily scaled up to meet added demand by increasing the number machines and databases within the system to match the increase in the number of users.

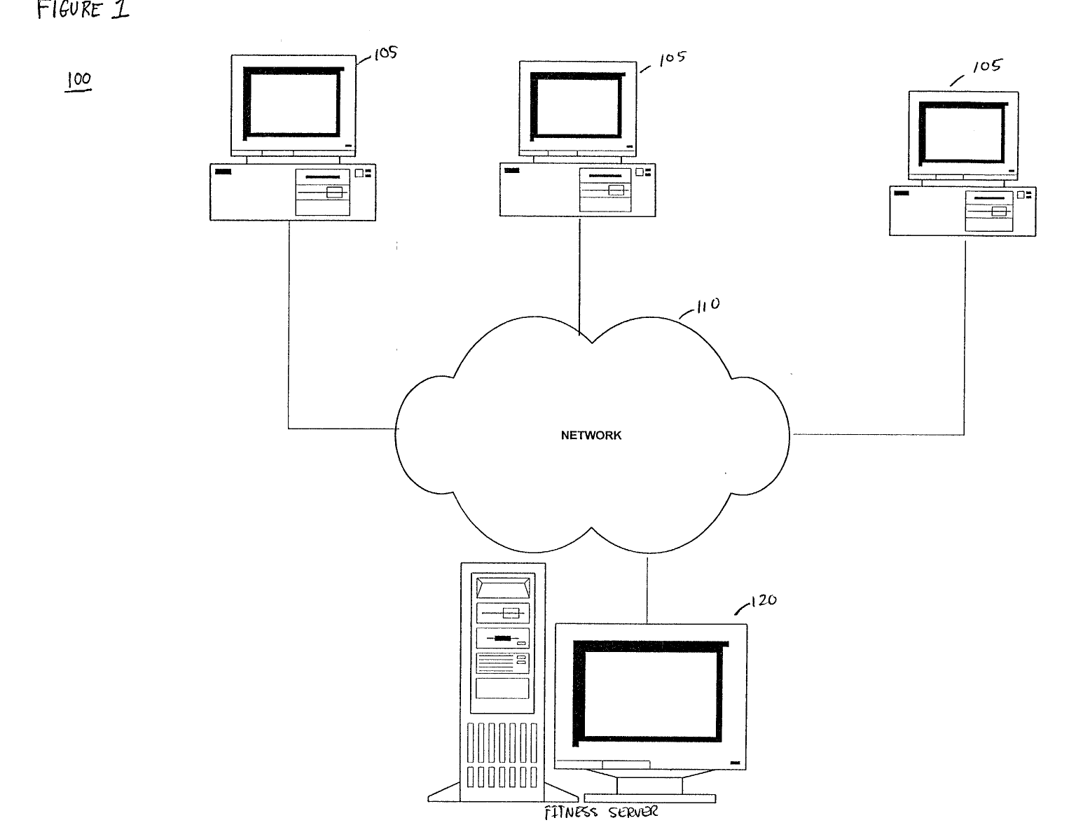

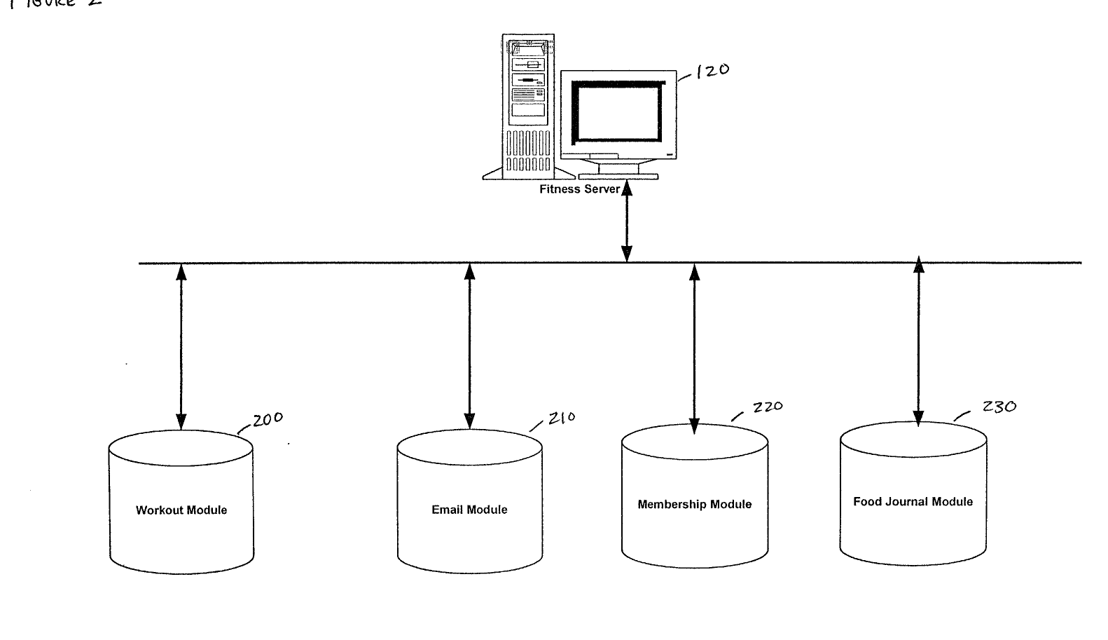

A fitness system of the present invention is generally depicted in FIG. 1 as 100. The fitness system may include one or more user computers 105. The fitness system 100 may also include one or more fitness servers 120. The fitness servers 120 are in communication with the user computers 105 through a global communications network 110. The global communications network 110 can be the Internet, a local area network, or the like. The user computers 105 may be any computer which can access the global communications networks.

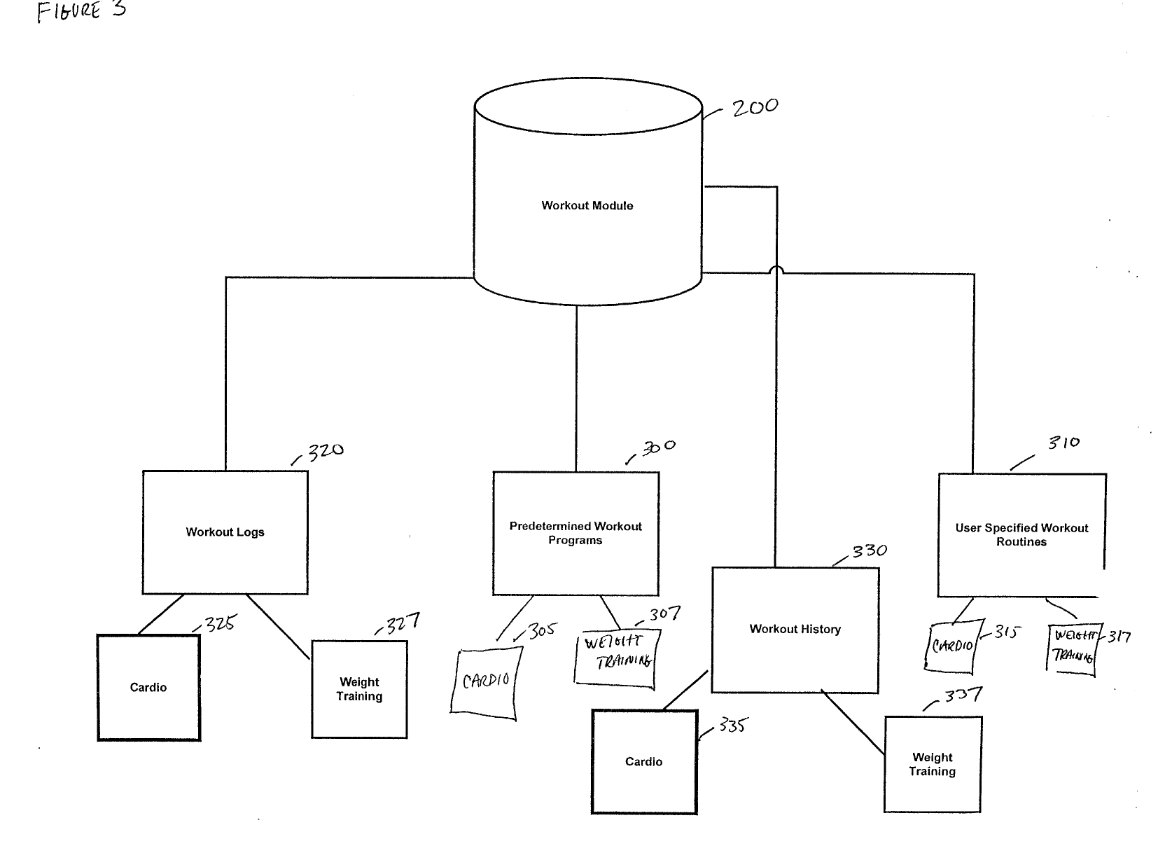

FIG. 2 illustrates in more detail the aspects of the fitness server 120. The fitness server 120 may include a workout module 200, an e-mail module 210, a membership module 220, and a food journal module 230. The workout module 200, the e-mail module 210, the membership 220, and the food journal module 230 are communicably linked to the fitness server 120 such that when the fitness server is accessed by a user through the global communications network, the fitness server may cull information from the different modules. Each module provides the fitness server with a variety of information and data storage capabilities for user information.

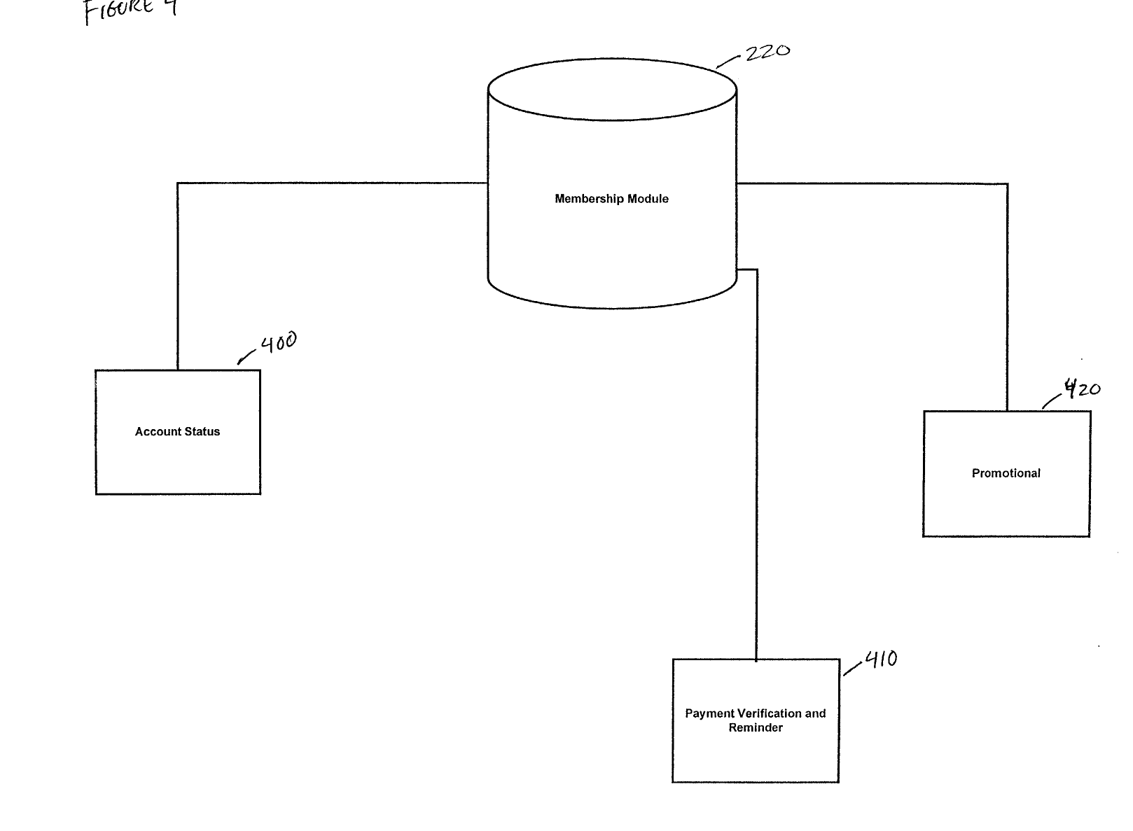

FIG. 3 diagrammatically illustrates the different components of the workout module 200. The workout module 200 may contain pre-determined workout programs, depicted as 300, or user specified workout programs, depicted as 310. The pre-determined workout programs 300 are generated by the system to provide the most efficient workout program to the user based upon the fitness level of the user and desired goals of the user. The pre-determined workout programs may include a cardiovascular workout portion 305 and a weight training portion 307.

Likewise, the user specified workout programs 310 may include a cardiovascular portion 315 and a weight training portion 317. The user specified workout programs 310 are created by the individual user based upon their own time and goals. The user may select or program the different cardiovascular and weight training exercises to be used with their workout program.

Additionally, the workout module 200 may include workout logs 320 and workout histories 330. The workout logs 320 allow the user to enter the workout information from each completed session in the workout program for the user. Each time the user enters the fitness system, the user may enter his workout log into the system. The workout log can then be recorded in either the cardiovascular portion 325 or the weight training portion 327, or both, depending upon the workout performed. Thus, as the user progresses through the workout program, the workout log keeps track of the progress of the user.

Likewise, the user will be able to access the workout history for the user. The workout history will contain completed workout programs by the user. The user can access the workout history 330 to determine the progress made by the user toward a goal. The goals set by the user may be to maintain a certain fitness level or weight level, to add muscle mass to the user, or to become more defined in muscle tone. The workout history 330 for each user will contain a cardiovascular history 335 and a weight training history 337.

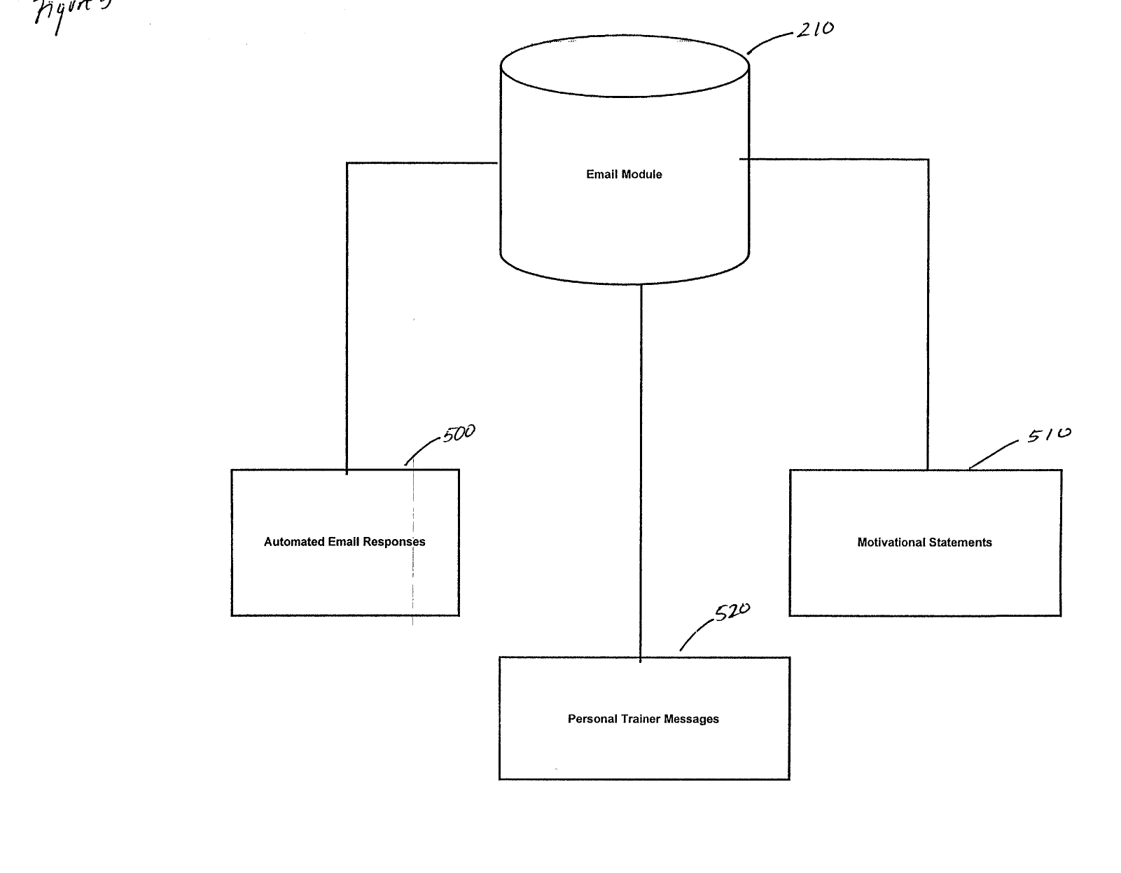

Referring now to FIG. 4, the components of the membership module 220 are diagrammatically illustrated. The membership module may include an account status verification component 400, a payment verification component 410 and a promotional component 420.

The account status verification component 400 allows the system to determine if the account of the user is current. Also, the account status component 400 allows the system to motivate individual users by warning them when their account is in jeopardy of being closed or temporarily interrupted. This occurs when the user has failed to meet workout objectives based upon the workout program specified by the user.

The payment verification component 410 allows the system to receive payments from the user and verify the payment information provided by the user before allowing the user to access the fitness system. The payment verification component 410 may include credit card verification components. Additionally, the membership module may include a promotional component 420. The promotional component 420 allows the user to indicate what, if any, promotional advertisement they wish to receive in connection with their use of the fitness system. The promotional component 420 allows the fitness system to generate advertisements based upon the preferences of the user. The advertisements can then be displayed to the user via the global communications network.

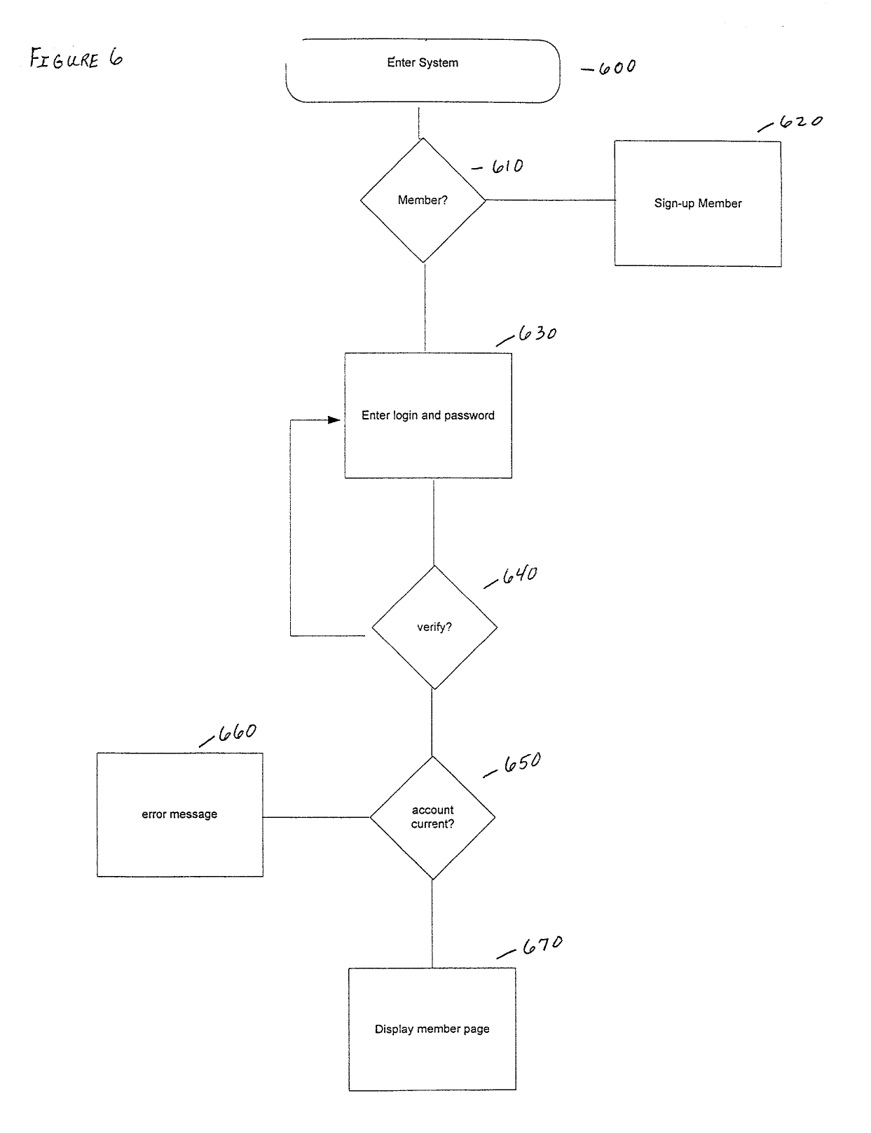

Referring now to FIG. 5, the components of the email module 210 are diagrammatically illustrated. The email module may include an automated e-mail response file 500, a motivational statement file 510, and a personal trainer message file 520. The automated e-mail response file 500 allows the fitness system to generate e-mail responses to each workout log entered on a daily or weekly basis. The automated e-mail responses contain inspirational or motivational messages that encourage the user to continue with the workout and their performance. Additionally, the automated e-mail responses may include suggested ideas for varying workout routines, varying eating habits, or varying cardiovascular exercise.

Similarly, the motivational statement file 510 allows the fitness system to generate motivational statements to each individual user based upon their workout performance. The motivational statements may be both in an encouraging form or a reinspiring form depending upon the performance of the user. If the user has failed to perform up to the expected goals for the workout program, the system may generate a statement to motivate that person to workout harder and meet the goals of the workout program. If, however, the user meets the expected goals of the workout program, the system may generate motivational statements which encourage the user to keep up with the good work and continue toward the goals of the workout program.

Additionally, personal trainer messages may be sent through the e-mail module to each user. Each user of the system will have a personal trainer to communicate with through e-mail or chat facilities. These personal trainers can relay messages on a more personal nature to each user under his or her training regimen. The personal trainer can then motivate using e-mail or chat mechanisms to encourage the user to continue with the workout program for a successful completion.

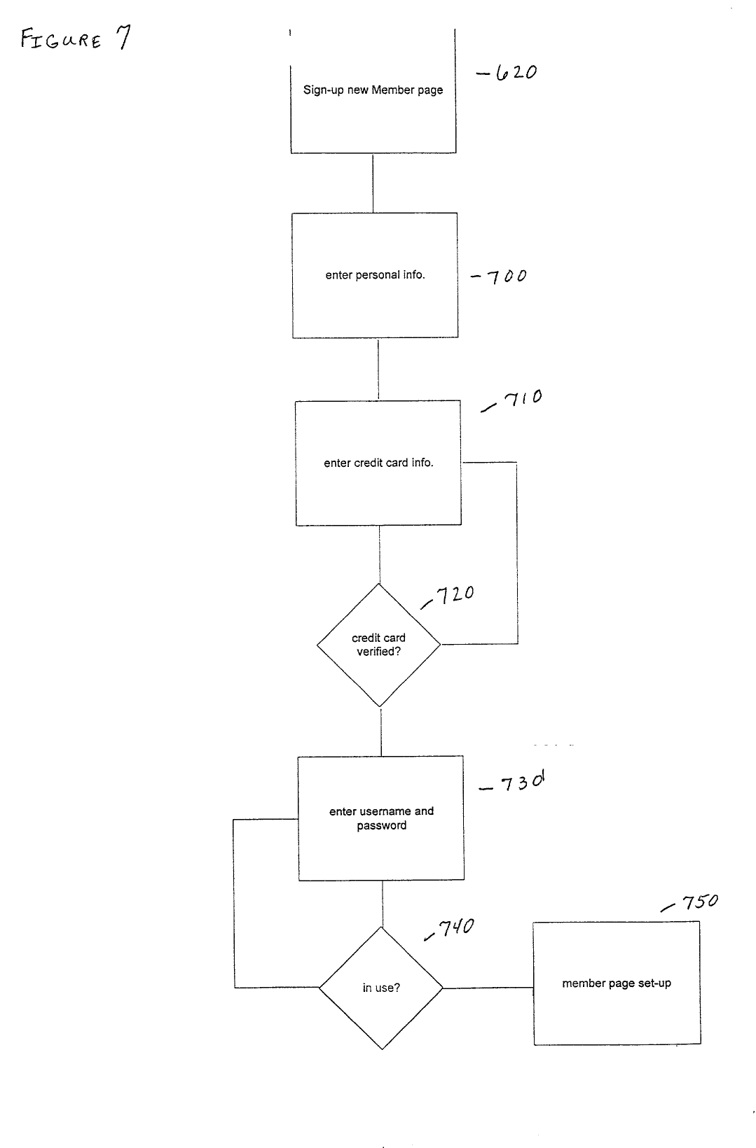

FIG. 6 is a block diagram showing the initial operation of the fitness system. The user enters the fitness system, as depicted by block 600, by accessing the web page hosting the fitness system. Once the user accesses the web page, the fitness system asks the user if they are a member of the fitness system, as in block 610. If the user is not a member of the fitness system, then the user is asked to sign up to be a member of the fitness system as in block 620. If, however, the user is a member of the fitness system, then the user is asked to enter their username and password, as in block 630.

Once the user has entered their username and password, the system attempts to verify the username and password, as in block 640. If the system is unable to verify the username and password, then the system will prompt the user to re-enter the username and password. If, however, the system is able to verify the username and password, then the system can check the account status of the user, as in block 650.

If the user is not current on his account, then the system generates an error message telling the user that his account status has lapsed or is deficient, as in block 660. If, however, the account status of the user is current, then the system displays the member page for the user, as in block 670.

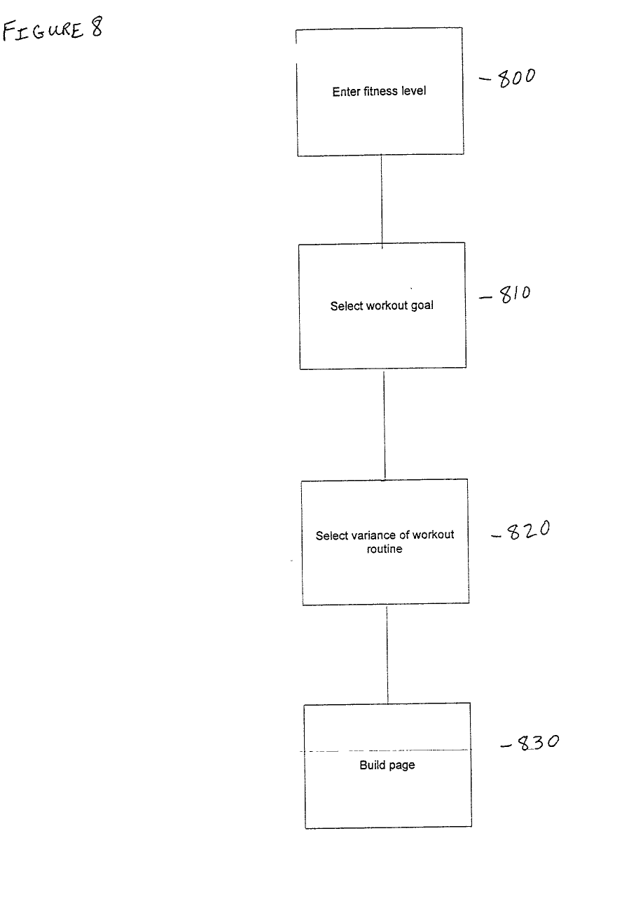

Referring now to FIG. 7, the mechanism by which the system signs up new members is shown in a block diagram. Once a user enters the system and the system determines that the user requires a new membership, the system displays the new member sign-up page, as in block 620. After the user enters the new member sign-up page, the system requests the user to enter the personal information of the user, as in block 700. This information may include the name, date of birth, address, age, weight, height and other distinguishing information of the user.

Additionally, the user may be asked to enter credit card information and a billing address for the credit card, as in block 710. The credit card information allows the system to credit payment to the user for the services of the fitness system. After the user enters the credit card information and other billing information, the system verifies the credit card information and the ability of the user to pay for the services, as in block 720. If the credit card information cannot be verified, then the system prompts the user to re-enter the credit card and billing information. If, however, the credit card information is verified, then the system asks the user to enter a username and password to be used to log into the system, as in block 730.

Once the username and password has been entered, the system checks to see if the username or password is in use by another current member, as in block 740. If the username and password are being used, then the system prompts the user to enter a new username and password. If, however, the username and password are not being used, then the system allows the user to proceed to create a membership page for the user, as in block 750.

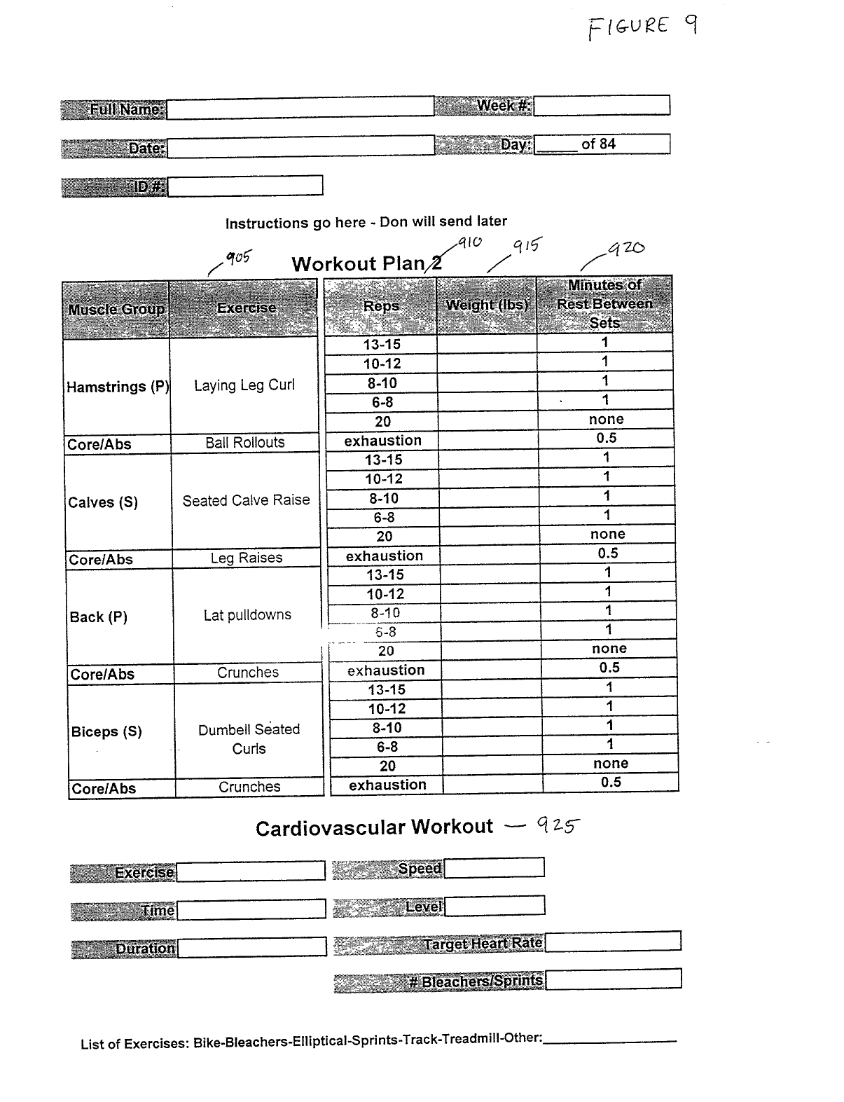

Referring now to FIG. 8, a block diagram showing the creation of the member page is given. Once the user is signed up as a new member, the system displays the creation page for new members, as in block 750. The creation page first asks the user to enter the fitness level appropriate to the user, as in block 800. The fitness level may be beginner, intermediate, advanced or other similar levels. After the user has entered the fitness level, the system prompts the user to select workout goal, as in block 810. The workout goals may be any defined fitness goal, for example, the user may wish to build more muscle mass, maintain a certain weight or physique level, or have a more defined physique. Other such fitness goals may be included in the system.

Once the user has selected a workout goal, the system prompts the user to select the variance of the workout routine, as in block 820. The variance of the workout routine may be on a daily basis, a weekly basis, a monthly basis. The variance may depend upon the desired goals of the user and fitness level of the user. After the user has selected the variance of the workout routine, the system then builds the member page for the user, as in block 830. In building the member page, the system generates workout logs both in the weight training area and the cardiovascular area pertaining to the workout goals and variance of workout routine selected by the user. The system also creates food journal entries for the user and selects appropriate motivational statements to be used with the user.

Once the user information is completed and the user has purchased a membership, the system immediately thanks the user for the purchased membership. The user is also welcomed to the network by first name of the user. The system also send the user a personal affirmation for completion by the user. The personal affirmation enables the user to keep a record of their workout goals.

Each time the user submits workout information, the system immediately congratulates the member. The system also reminds the user of the adherence program incorporated into the system. The member will then be asked to read and agree to the adherence policy. Likewise, after a food journal entry is made, the system congratulates the member via the email module. The work out information is required by the system, the food journal is optional.

Users can renew their membership at any time, via the global communications network, including if the membership of the user has expired or if the user has been removed from the system. User membership may be removed if the user does not log on at least once in any consecutive three week period. Users can renew membership at same price. After three consecutive weekly “No Shows,” the system recognizes and removes the users.

Memberships are valid for 12 consecutive months after purchase date. The email module automatically sends the a website address to each user so that each user can log on to submit his/her weekly workout. The system attaches and sends each user goals from their personal information and sends it to the user as a reminder if a user fails to log on and send in his/her workout information during any one week period. The email module automatically selects and send one motivational email, quote/statement every four days. The email module selects these from four batch categories, according to a personality assessment score for each user.

The system will begin logging user weekly adherence immediately. The week starts on Monday and each week ends on Sunday. The adherence policy encourages users to log on and send in their workout information once a week. Users will complete a personal information page when joining and each user must fill in a goal section. The goal will be emailed directly to the user as a reminder. Users have the option of logging on and going to the exercise log page to maintain their membership by clicking on the “extenuating circumstances” button for those weeks in which no workout was completed. The system recognizes this to be the same as a normal workout log entry. The system places the identification number of the user in the good or bad standing file according to the adherence of the user. Users do not have to send in workouts once a week but they must log on to send in their workouts (according to adherence/accountability policy) or click on “extenuating circumstances” button at least once every three weeks in order to maintain their membership through the system.

If a user does not desire to use a workout log, the user may use a four component wheel system to enter the workouts of the user. The wheel system includes a nutrition wheel, a cardiovascular wheel, a flexibility wheel, and a weight training wheel. The wheels appear to the user as buttons. The user may click the wheel button they wish to enter into the system. By selecting a button, the system will be updated to include the portion of the workout the user has completed for a particular day or week, the same as far as a normal workout log entry.

Each user will be asked to fill out a personal information page. Users may update their information at any time and submit to update their information. Users will receive e-cards on their birth date, when they reach a specified goal, and for certain holidays, all through the email module.

Users click on the weekly exercise log button in order to access the exercise log spreadsheet, shown in FIG. 9. The exercise log sheet is accessible for each user to use their mouse and click on each exercise, set, repetition, weight, and rest interval used for each particular workout, as shown by 905,910,915,and 920. Users will also use their mouse to click to enter their cardiovascular exercise entered for each day they do cardiovascular exercise, as indicated by 925. Each movement within the log will be selected through the use of a mouse or keypad.

Users may also have access to cyber trainers through a call-center type environment using 1-800 number, instant messaging, chat, and e-mail. Cyber Trainers will be online to support the user. Users may reach the cyber trainer on line through instant messaging, chat or calling the 800 number and giving their identification number.

What is claimed is:

1. An fitness system for use across a telecommunications network comprising:
one or more computers having one or more users desiring motivational support for workouts; and
a fitness server communicably linked to the one or more computers through the telecommunications network and being configured to provide exercise routines, parameters, tracking, and motivational assistance.

2. The fitness system of claim 1 wherein the fitness server includes a workout module, a membership module, a food module, and a email module.

3. The fitness system of claim 2 wherein the workout module includes workout routines.

4. The fitness system of claim 3 wherein the workout routines are predetermined workout programs.

5. The fitness system of claim 3 wherein the workout routines are user specified workout programs.

6. The fitness system of claim of claim 4 wherein the predetermined workout programs are daily workout routines.

7. The fitness system of claim 4 wherein the predetermined workout programs are weekly workout routines.

8. The fitness system of claim 4 wherein the predetermined workout programs are

9. The fitness system of claim 2 wherein the workout module includes workout logs.

10. The fitness system of claim 9 wherein the workout logs correspond to one or more users.

11. The fitness system of claim 2 wherein the workout module includes workout histories.

12. The fitness system of claim 11 wherein the workout histories correspond to one or more users.

13. The fitness system of claim 2 wherein the membership module includes payment mechanism.

14. The system of claim 13 wherein the payment mechanism allows the membership module to verify payment information supplied by one or more users.

15. The system of claim 2 wherein the membership module is configured to update and verify the account status of one or more users.

16. The system of claim 2 wherein the email module is configured to provide motivational messages to one or more users.

17. The system of claim 2 wherein the food module is configured to provide nutritional guidance to one or more users.

18. The system of claim 1 wherein the global communications network is the Internet.

19. A method of personal training across a global communications network comprising the steps of:
specifying a fitness level for atleast one person;
electing a goal for the person;
selecting a workout program corresponding to the goal;
charting progress of the person in the chosen workout program;
providing motivational statements to the person via the global communications network, wherein the motivational statements encourage the person to continue with and fulfill the workout program.

20. The method of claim 19 wherein the fitness level is beginner.

21. The method of claim 19 wherein the fitness level is intermediate.

22. The method of claim 19 wherein the fitness level is advanced.

23. The method of claim 19 wherein the step of charting is performed using atleast a first workout log and at least a second workout log.

24. The method of claim 23 wherein the first workout log is a weight training log.

25. The method of claim 23 wherein the second workout log is a cardiovascular log.

26. The method of claim 19 wherein the global communications network is the Internet.
